(19) United States
(12) Patent Application Publication
(10) Pub. No.: US 2014/0361732 A1
(43) Pub. Date: Dec. 11, 2014

(54) STORAGE BATTERY CONTROL DEVICE, STORAGE BATTERY CONTROL METHOD, PROGRAM, POWER STORAGE SYSTEM AND POWER SUPPLY SYSTEM

(71) Applicant: OMRON Corporation, KYOTO (JP)

(72) Inventors: Takeo Nishikawa, Kyoto (JP); Yoshinori Sunahata, Shiga (JP); Junichiro Yamada, Kyoto (JP); Wataru Okada, Kyoto (JP); Makoto Ohashi, Kyoto (JP)

(73) Assignee: OMRON CORPORATION, KYOTO (JP)

(21) Appl. No.: 14/373,440

(22) PCT Filed: Jan. 24, 2013
(86) PCT No.: PCT/JP2013/051376

§ 371 Date: Jul. 21, 2014

(30) Foreign Application Priority Data
Feb. 28, 2012 (JP) 2012-041027

(51) Int. Cl. H02J 7/00

(52) U.S. Cl. CPC H02J 7/00
USPC 320/107

(57) ABSTRACT

A storage battery control device includes a storage battery control method, a program, a power storage system and a power supply system which can fulfill better performance with a configuration where a plurality of storage batteries are connected. A storage battery to be charged is determined based on the states of charge and the numbers of times of charge/discharge obtained from the plurality of storage batteries referring to a charge order table to which an order to charge storage batteries is set according to states of charge and numbers of times of charge and discharge of storage batteries to be charged with power. The order to charge the storage batteries is preferentially set to a row of cells whose numbers of times of charge and discharge are small and is preferentially set to cells of each row whose states of charge are low in the charge order table.

### TECHNICAL FIELD

The present disclosure relates to a storage battery control device, a storage battery control method, a program, a power storage system and a power supply system. More particularly, the present disclosure relates to a storage battery control device, a storage battery control method, a program, a power storage system and a power supply system which can fulfill better performance with a configuration where a plurality of storage batteries are connected.

### BACKGROUND ART

Conventionally, a power storage system configured by connecting a plurality of storage batteries to obtain a predetermined capacity which cannot be obtained by one storage battery is used. According to such a power storage system, performance of the power storage system differs depending on a control method of charging or discharging each storage battery.

For example, Patent Document 1 discloses a power storage system which prevents over discharge of storage batteries in storing by individually detecting voltages of a plurality of storage batteries connected in parallel and charging storage batteries whose voltages are a threshold or less to storage voltages.

Further, a conventional charging system performs charging according to a control method based on a point of view of safely performing charging or performing charging until storage batteries are fully charged. Hence, a charging amount has been determined by, for example, measuring a voltage, a temperature, a current and an internal resistance of a storage battery.

### PRIOR ART DOCUMENT

### Patent Document

Patent Document 1: Japanese Unexamined Patent Publication No. 2009-81078

### SUMMARY OF THE INVENTION

### Problems to be Solved by the Invention

By the way, the power storage system disclosed in Patent Document 1 only controls charging based on voltages of a plurality of storage batteries, and does not take into account, for example, the numbers of times of charge and discharge which influence storage battery operating lives. Therefore, the numbers of times of charge and discharge of a plurality of storage batteries vary in some cases and respective storage battery operating lives become disproportionate, and therefore it is assumed that an operating life of the power storage system shortens as a whole.

Further, the conventional power storage system performs charging according to the control method based on the point of view of safely performing charging or performing charging until the storage batteries are fully charged, and therefore states of charge of the respective storage batteries vary in some cases. In this case, it is assumed that a time for driving at a maximum capacity upon, for example, blackout shortens in the conventional power storage system.

Hence, the charging system configured by connecting a plurality of storage batteries has been demanded to fulfill good performance as a whole by making the operating life of the entire system longer, and making longer a time for driving at a maximum capacity upon blackout.

The present disclosure has been made in light of this situation, and can fulfill better performance with a configuration where a plurality of storage batteries are connected.

### Means for Solving the Problem

A storage battery control device according to one aspect of the present disclosure has: a setting unit configured to be set in advance with an order to charge or discharge a storage battery according to at least two parameters configured to define an operating life and an output of the storage battery configured to store power; and a determining unit configured to determine the storage battery to be charged or discharged among a plurality of storage batteries based on the parameters obtained from the plurality of storage batteries referring to the order set in advance to the setting unit.

With a storage battery control method or a program according to one aspect of the present disclosure, an order to charge or discharge a storage battery is set in advance according to at least two parameters configured to define an operating life and an output of the storage battery configured to store power, and the storage battery control method or the program includes a step of determining the storage battery to be charged or discharged among a plurality of storage batteries based on the parameters obtained from the plurality of storage batteries referring to the order set in advance.

A power storage system according to one aspect of the present disclosure has: a plurality of storage batteries configured to store power; a setting unit configured to be set in advance with an order to charge or discharge the storage batteries according to at least two parameters configured to define operating lives and outputs of the storage batteries; and a determining unit configured to determine the storage battery to be charged or discharged among the plurality of storage batteries based on the parameters obtained from the plurality of storage batteries referring to the order set in advance to the setting unit.

A power supply system according to one aspect of the present disclosure has: a power supply configured to include at least one of a direct-current power supply configured to supply power by using natural energy and an alternating-current power supply configured to supply power through a power system; a load configured to be connected to the power supply through a power wiring and consume power; a plurality of storage batteries configured to be connected in parallel to the power supply through the power wiring and store the power; a setting unit configured to be set in advance with an order to charge or discharge the storage batteries according to at least two parameters configured to define operating lives and outputs of the storage batteries; and a determining unit configured to determine the storage battery to be charged or discharged among the plurality of storage batteries based on the parameters obtained from the plurality of storage batteries referring to the order set in advance to the setting unit.

According to one aspect of the present disclosure, an order to charge or discharge the storage batteries is set in advance according to at least two parameters configured to define operating lives and outputs of the storage batteries, and the storage battery to be charged or discharged among the plurality of storage batteries is determined based on the parameters obtained from the plurality of storage batteries referring to the order.

### Effect of the Invention

According to one aspect of the present disclosure, it is possible to fulfill better performance with a configuration where a plurality of storage batteries are connected.

### BRIEF DESCRIPTION OF THE DRAWINGS

FIG. 1 is a block diagram illustrating a configuration example of a power storage system of a first embodiment to which the present technology is applied.

FIG. 2 is a view explaining a charge order table.

FIG. 3 is a block diagram illustrating a configuration example of a storage battery control device.

FIG. 4 is a view explaining an order to charge storage batteries referring to the charge order table.

FIG. 5 is a view explaining an order to charge the storage batteries referring to the charge order table.

FIG. 6 is a flowchart explaining processing of controlling charging of storage batteries.

FIGS. 7A and 7B are views explaining times for driving at a maximum capacity upon blackout.

FIG. 8 is a view explaining a discharge order table.

FIG. 9 is a block diagram illustrating a configuration example of a power storage system of a second embodiment to which the present technology is applied.

### MODE FOR CARRYING OUT THE INVENTION

Hereinafter, specific embodiments to which the present technology is applied will be described in detail with reference to the drawings.

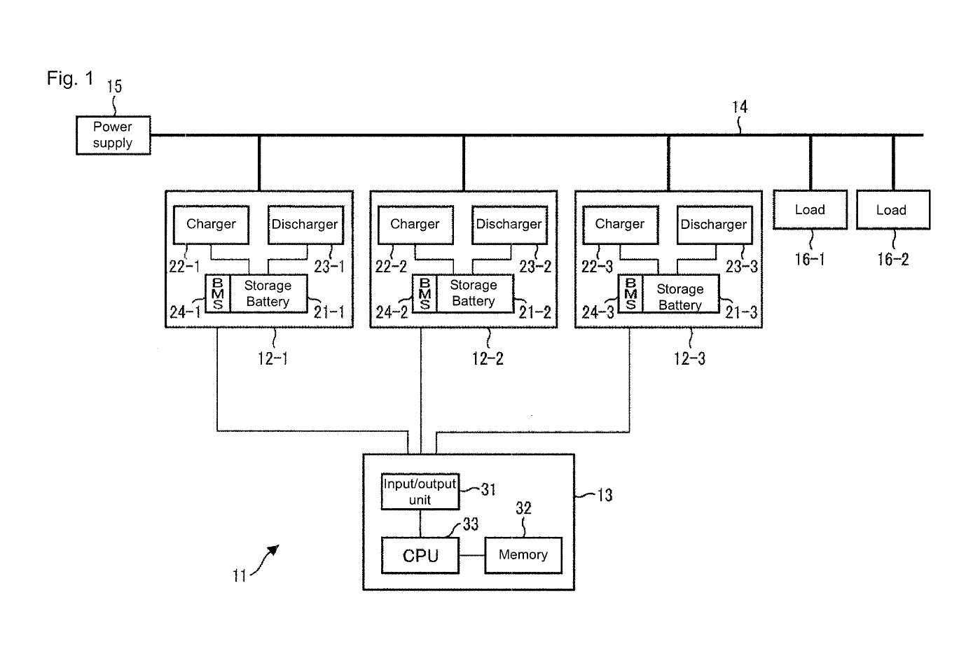

FIG. 1 is a block diagram illustrating a configuration example of a power storage system of a first embodiment to which the present technology is applied.

In FIG. 1, power storage system 11 is configured to have three power storage devices 12-1 to 12-3, and control device 13. Further, a power supply system including power storage system 11 is configured to be connected, through power wiring 14 which transmits power, with power supply 15 which supplies power through a power system and with loads 16-1 and 16-2 which consume power. Furthermore, power supply 15 includes a direct-current power supply which uses natural energy such as sunlight or wind power or uses a fuel cell, and an alternating-current power supply such as a commercial power supply which supplies power through a power system.

Power storage devices 12-1 to 12-3 are connected in parallel to power supply 15 through power wiring 14, and are connected to loads 16-1 and 16-2. Further, power storage devices 12-1 to 12-3 store power supplied from power supply 15 through power wiring 14, and supply the stored power to loads 16-1 and 16-2 through power wiring 14.

Furthermore, power storage devices 12-1 to 12-3 are each configured to have storage batteries 21-1 to 21-3, chargers 22-1 to 22-3, dischargers 23-1 to 23-3 and battery management systems (BMS) 24-1 to 24-3. In addition, power storage devices 12-1 to 12-3 are each configured likewise, and, when power storage devices 12-1 to 12-3 do not need to be distinguished, power storage devices 12-1 to 12-3 are referred to as power storage device 12 below. Further, the same also applies to storage batteries 21-1 to 21-3, chargers 22-1 to 22-3, dischargers 23-1 to 23-3 and battery management systems 24-1 to 24-3.

Storage battery 21 can store power of a predetermined capacity, and can maintain defined charging capability until storage battery is charged and discharged a defined number of times. In this regard, a rate of the amount of remaining charged power stored in storage battery 21 to a rating capacity of power which storage battery 21 can store is referred to as a state of charge of storage battery 21, and the number of times storage battery 21 is charged and discharged is referred to as the number of times of charge and discharge. In addition, the state of charge defines an output of storage battery 21, and the number of times of charge and discharge defines an operating life of storage battery 21.

Charger 22 AC/DC-converts power supplied through power wiring 14 according to a voltage of storage battery 21 under control of control device 13, and charges storage battery 21.

Discharger 23 DC/AC-converts the power stored in storage battery 21 under control of control device 13, outputs the power to power wiring 14 according to, for example, a phase of the power transmitted through power wiring 14 and supplies the power to loads 16-1 and 16-2.

Battery management system 24 communicates with control device 13, and manages storage battery 21. For example, battery management system 24 measures the state of charge of storage battery 21, counts the number of times of charge and discharge of storage battery 21, and transmits data indicating the state of charge and the number of times of charge and discharge of storage battery 21 to control device 13.

Control device 13 is configured to have input/output unit 31, memory 32 and CPU (Central Processing Unit) 33.

Input/output unit 31 is an interface for communicating with power storage device 12, and obtains the data transmitted from battery management system 24, transmits a control signal for instructing charger 22 to perform charging and transmits a control signal for instructing discharger 23 to perform discharging.

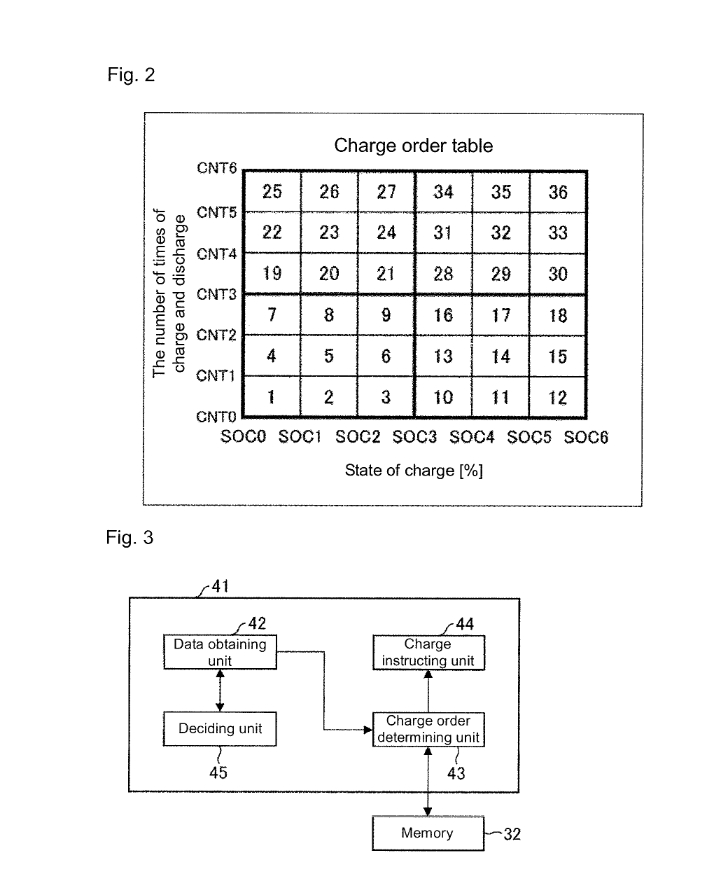

Memory 32 stores programs executed by CPU 33 and various items of data which CPU 33 requires to execute the programs. For example, memory 32 stores a charge order table (see FIG. 2 described below) to which is referred to determine charge orders of power storage devices 12-1 to 12-3 when CPU 33 executes a program of controlling charging of power storage devices 12-1 to 12-3.

CPU 33 reads and executes the program stored in memory 32, controls entire power storage system 11 and controls, for example, charging of power storage devices 12-1 to 12-3.

Next, the charge order table stored in memory 32 will be described with reference to FIG. 2.

As illustrated in FIG. 2, the charge order table is set based on states of charge and the numbers of times of charge and discharge of storage batteries 21. In an example in FIG. 2, the charge order table is formed with cells of 6 rows×6 columns, and charge order “1” of the highest priority to charge order “36” of the lowest priority is set to each cell of the charge order table.

A column direction of the charge order table is partitioned by the numbers of times of charge and discharge CNT0 to CNT6. The number of times of charge and discharge CNT0 is set to 0 time and the number of times of charge and discharge CNT6 is set to, for example, the number of times (e.g. 3000 to 4000 times) matching charging capability of storage battery 21. Further, the number of times of charge and discharge CNT3 is set as, for example, a first threshold serving as a criterion to encourage an exchange of storage battery 21 to the number of times obtained by adding a predetermined margin coefficient to the number of times obtained by integrating the average number of times of charge and discharge per day with the number of days spent until storage battery 21 is exchanged. Further, the numbers of times of charge and discharge CNT1 and CNT2 are set to equally partition the number of times of charge and discharge CNT0 to the number of times of charge and discharge CNT3. The numbers of times of charge and discharge CNT4 and CNT5 are set to equally partition the number of times of charge and discharge CNT3 to the number of times of charge and discharge CNT6. In addition, the numbers of times of charge and discharge CNT1 and CNT2, and the numbers of times of charge and discharge CNT4 and CNT5 may be set at an arbitrary rate instead of being equally partitioned.

The row direction of the charge order table is partitioned by states of charge SOC0 to SOC6, and, for example, state of charge SOC0 is set to 0% and state of charge SOC6 is set to 100%. Further, state of charge SOC3 is set as, for example, a second threshold serving as a criterion to decide whether or not to perform processing of determining charge orders, to a numerical value obtained by adding a predetermined margin coefficient to, for example, a numerical value obtained by dividing a value obtained by integrating a necessary time and necessary power by a rating capacity of storage battery 21. Furthermore, states of charge SOC1 and SOC2 are set to equally partition state of charge SOC0 to state of charge SOC3. States of charge SOC4 and SOC5 are set to equally partition state of charge SOC3 to state of charge SOC6.

Consequently, the charge order table is classified into first to fourth groups based on the number of times of charge and discharge CNT3 as the first threshold and state of charge SOC3 as the second threshold. The first group is formed with nine cells whose numbers of times of charge and discharge are the number of times of charge and discharge CNT3 or less and whose states of charge are state of charge SOC3 or less. The second group is formed with nine cells whose numbers of times of charge are the number of times of charge and discharge CNT3 or less and whose states of charge are higher than state of charge SOC3. Further, the third group is formed with nine cells whose numbers of times of charge and discharge are larger than the number of times of charge and discharge CNT3 and whose states of charge are state of charge SOC3 or less. The fourth group is formed with nine cells whose numbers of times of charge and discharge are larger than the number of times of charge and discharge CNT3 and whose states of charge are higher than state of charge SOC3.

Furthermore, charge order “1” to charge order “9” of the highest priorities are set to the nine cells of the first group. Charge order “10” to charge order “18” of the next highest priorities to those of the first group are set to the nine cells of the second group. Still further, charge order “19” to charge order “27” of the next highest priorities to those of the second group are set to the nine cells of the third group. Charge order “28” to charge order “36” of the next highest priorities to those of the third group are set to the nine cells of the fourth group.

Moreover, in each group, charge orders of higher priorities are sequentially set preferentially to a row of cells whose numbers of times of charge and discharge are small and preferentially to cells of each row whose states of charge are low.

That is, in the first group and, first, in a row of cells whose numbers of times of charge and discharge are the smallest and which are partitioned by the numbers of times of charge and discharge CNT0 and CNT1, charge order “1” is set to a cell whose state of charge is the lowest and which is partitioned by states of charge SOC0 and SOC1, charge order “2” is set to a cell whose state of charge is the next lowest and which is partitioned by states of charge SOC1 and SOC2, and charge order “3” is set to a cell whose state of charge is the further next lowest and which is partitioned by states of charge SOC2 and SOC3. Next, in a row of cells whose numbers of times of charge and discharge are the second smallest and which are partitioned by the numbers of times of charge and discharge CNT1 and CNT2, charge order “4” is set to a cell whose state of charge is the lowest and which is partitioned by states of charge SOC0 and SOC1, charge order “5” is set to a cell whose state of charge is the second lowest and which is partitioned by states of charge SOC1 and SOC2, and charge order “6” is set to a cell whose state of charge is the further next lowest and which is partitioned by states of charge SOC2 and SOC3.

Further, in a row of cells whose number of times of charge and discharge is the third smallest and which is partitioned by the numbers of times charge and discharge CNT2 and CNT3, charge order “7” is set to a cell whose state of charge is the lowest and which is partitioned by states of charge SOC0 and SOC1, charge order “8” is set to a cell whose state of charge is the next lowest and which is partitioned by states of charge SOC1 and SOC2, and charge order “9” is set to a cell whose state of charge is the further next lowest and which is partitioned by states of charge SOC2 and SOC3.

Thus, in the first group, charge order “1” to charge order “9” are set preferentially to a row of cells whose numbers of times of charge and discharge are small and preferentially to cells of each row whose states of charge are low.

Similarly, charge order “10” to charge order “18” are set in the second group, charge order “19” to charge order “27” are set in the third group and charge order “28” to charge order “36” are set in the fourth group.

A charge order table to which the charge orders are set in this way is stored in memory 32 of control device 13. Further, control device 13 achieves a function of the storage battery control device when CPU 33 executes a program of determining a charge order of power storage device 12 referring to the charge order table and controlling charging of power storage device 12 based on this charge order.

Next, FIG. 3 illustrates a functional block diagram where CPU 33 functions as the storage battery control device which determines a charge order of power storage device 12 referring to a charge order table and controls charging of power storage device 12 based on this charge order.

As illustrated in FIG. 3, storage battery control device 41 is configured to have data obtaining unit 42, charge order determining unit 43, charge instructing unit 44 and deciding unit 45.

Data obtaining unit 42 communicates with battery management systems 24-1 to 24-3 of power storage devices 12-1 to 12-3, respectively on a regular basis through input/output unit 31 in FIG. 1, and obtains data indicating states of charge and the numbers of times of charge and discharge of storage batteries 21-1 to 21-3. Further, data obtaining unit 42 supplies the data indicating the states of charge and the numbers of times of charge and discharge of storage batteries 21-1 to 21-3, to charge order determining unit 43 and deciding unit 45.

Charge order determining unit 43 determines charge orders of storage batteries 21-1 to 21-3 referring to the charge order table stored in memory 32 based on the data supplied from data obtaining unit 42 and indicating the states of charge and the numbers of times of charge and discharge of storage batteries 21-1 to 21-3.

Charge instructing unit 44 selects storage battery 21 to be charged according to the charge orders of storage batteries 21-1 to 21-3 determined by charge order determining unit 43. For example, to charge storage batteries 21-1 to 21-3 one by one, charge instructing unit 44 selects storage battery 21 whose charge order is determined as the highest priority among the charge orders of storage batteries 21-1 to 21-3, as storage battery 21 to be charged. Further, charge instructing unit 44 transmits a control signal for instructing charging to charger 22 of selected storage battery 21 through input/output unit 31 to cause charger 22 to charge storage battery 21.

Deciding unit 45 decides whether or not to perform processing of determining charge orders by charge order determining unit 43, based on the data obtained by data obtaining unit 42 on a regular basis and indicating the states of charge of storage batteries 21-1 to 21-3. When, for example, the state of charge of storage battery 21 which is being charged reaches 100% and when the state of charge of storage battery 21 which is being charged exceeds the above second threshold, deciding unit 45 decides to perform processing of determining charge orders by charge order determining unit 43.

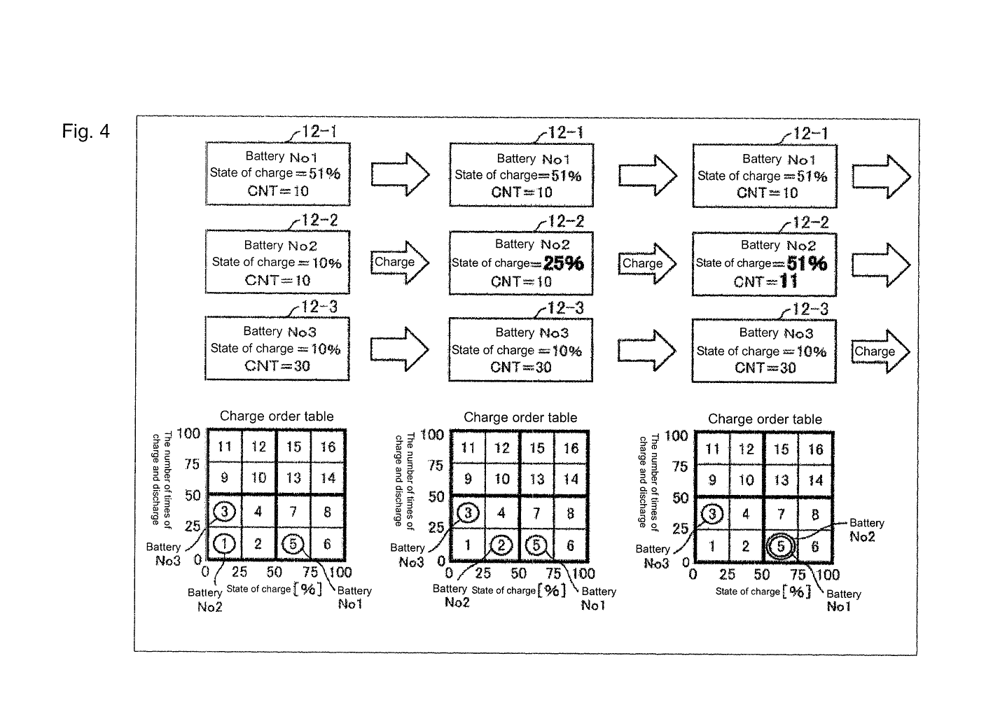

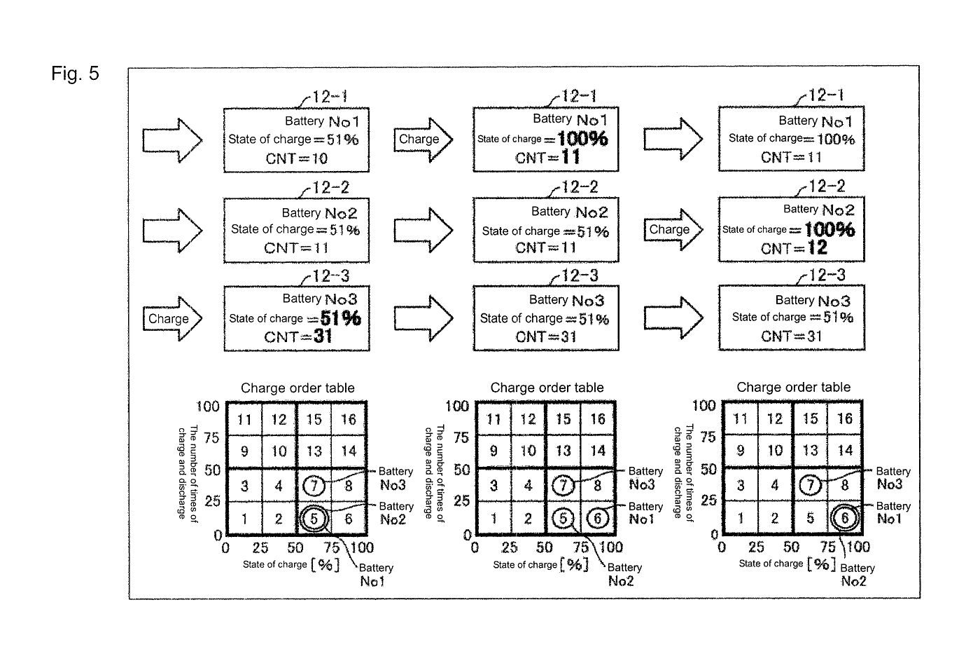

Next, an order that storage batteries 21-1 to 21-3 are charged under control of storage battery control device 41 will be described with reference to FIGS. 4 and 5.

In addition, FIGS. 4 and 5 will be described using the charge order table in which the column direction is partitioned by the numbers of times of charge and discharge of 0 time, 25 times, 50 times, 75 times and 100 times, and the row direction is partitioned by states of charge of 0%, 25%, 50%, 75% and 100%. Further, in this charge order table, the above first threshold is set to 50 times, the above second threshold is set to 50%, and charge order “1” to charge order “16” are set.

As illustrated on, for example, a left side in FIG. 4, data obtained by data obtaining unit 42 indicates that the state of charge of storage battery 21-1 is 51% and the number of times of charge and discharge of storage battery 21-1 is 10 times. Similarly, the data indicates that the state of charge of storage battery 21-2 is 10% and the number of times of charge and discharge of storage battery 21-2 is 10 times. The data indicates that the state of charge of storage battery 21-3 is 10% and the number of times of charge and discharge of storage battery 21-3 is 30 times.

In this case, since the state of charge of storage battery 21-1 exceeds 50% and is 75% or less and the number of times of charge and discharge of storage battery 21-1 is 25 times or less, charge order determining unit 43 determines charge order “5” for storage battery 21-1. Further, since the state of charge of storage battery 21-2 is 25% or less and the number of times of charge and discharge of storage battery 21-2 is 25 times or less, charge order determining unit 43 determines charge order “1” for storage battery 21-2. Similarly, since the state of charge of storage battery 21-3 is 25% or less and the number of times of charge and discharge of storage battery 21-3 is larger than 25 times and is 50 times or less charge order determining unit 43 determines charge order “3” for storage battery 21-2.

Hence, charge instructing unit 44 transmits a control signal for instructing charging of storage battery 21-2 to which charge order “1” of the highest priority among storage batteries 21-1 to 21-3 is set, and discharger 23-2 charges storage battery 21-2.

Subsequently, as indicated in the center in FIG. 4, the state of charge of storage battery 21-2 which is being charged reaches 25%, charging continues as is and, as indicated on the right side in FIG. 4, the state of charge of storage battery 21-2 which is being charged exceeds 50% which is the second threshold and reaches 51%. In this case, deciding unit 45 decides to perform processing of determining charge orders when the state of charge of storage battery 21-2 which is being charged exceeds 50% which is the second threshold, based on the data obtained by data obtaining unit 42 on a regular basis.

In response to this decision, data obtaining unit 42 obtains data indicating states of charge and the numbers of times of charge and discharge of storage batteries 21-1 to 21-3, and charge order determining unit 43 performs processing of determining charge orders based on these items of data.

In the example in FIG. 4, in response to a change of the state of charge of storage battery 21-2 to 51%, charge state determining unit 43 determines charge order “5” for storage battery 21-2 referring to the charge order table. In addition, the state of charge and the number of times of charge and discharge of storage battery 21-1 do not change, and therefore storage battery 21-1 keeps charge order “5” and, similarly, storage battery 21-3 keeps charge order “3”.

Hence, charge instructing unit 44 transmits a control signal for instructing charging of storage battery 21-3 to which charge order “3” of the highest priority is set among storage batteries 21-1 to 21-3, and discharger 23-3 charges storage battery 21-3. Further, at this time, charging of storage battery 21-2 is finished, and the number of times of charge and discharge of storage battery 21-2 is counted up and becomes 11 times.

Subsequently, as illustrated on the left side in FIG. 5, when storage battery 21-3 is charged, the state of charge of storage battery 21-3 exceeds 50% which is the second threshold and reaches 51%. In this regard, deciding unit 45 decides to perform processing of determining charge orders based on the data obtained by data obtaining unit 42 on a regular basis when the state of charge of storage battery 21-3 which is being charged exceeds 50% which is the second threshold.

In response to this decision, data obtaining unit 42 obtains data indicating states of charge and the numbers of times of charge and discharge of storage batteries 21-1 to 21-3, and charge order determining unit 43 performs processing of determining charge orders based on these items of data.

In the example in FIG. 5, in response to a change of the state of charge of storage battery 21-3 to 51%, charge state determining unit 43 determines charge order “7” for storage battery 21-3 referring to the charge order table. In addition, the state of charge and the number of times of charge and discharge of storage battery 21-1 do not change, and therefore storage battery 21-1 keeps charge order “5” and, similarly, storage battery 21-2 keeps charge order “5”.

In this regard, storage batteries 21-1 and 21-2 both have same charge order “5”. In this case, charge instructing unit 44 compares the numbers of times of charge and discharge of storage batteries 21-1 and 21-2, and selects one of storage batteries 21-1 and 21-2 whose number of times of charge and discharge is smaller as storage battery 21 to be charged. That is, in this case, the number of times of charge and discharge of storage battery 21-1 is 10 times and the number of times of charge and discharge of storage battery 21-2 is 11 times, so that charge instructing unit 44 instructs charging of storage battery 21-1 and transmits a control signal for instructing charging of storage battery 21-1. In response to the control signal, discharger 23-1 charges storage battery 21-1. Further, at this time, charging of storage battery 21-3 is finished, and the number of times of charge and discharge of storage battery 21-3 is counted up and becomes 31 times.

Subsequently, as illustrated in a center in FIG. 5, when storage battery 21-1 is charged until the state of charge reaches 100%, deciding unit 45 decides to perform processing of determining charge orders based on the data obtained by data obtaining unit 42 on a regular basis.

In response to this decision, data obtaining unit 42 obtains data indicating states of charge and the numbers of times of charge and discharge of storage batteries 21-1 to 21-3, and charge order determining unit 43 performs processing of determining charge orders based on these items of data.

In the example in FIG. 5, in response to a change of the state of charge of storage battery 21-1 to 100%, charge state determining unit 43 determines charge order “6” for storage battery 21-1 referring to the charge order table. In addition, the state of charge and the number of times of charge and discharge of storage battery 21-2 do not change, and therefore storage battery 21-2 keeps charge order “5” and, similarly, storage battery 21-3 keeps charge order “7”.

Hence, charge instructing unit 44 transmits a control signal for instructing charging of storage battery 21-2 to which charge order “5” of the highest priority is set among storage batteries 21-1 to 21-3, and discharger 23-2 charges storage battery 21-2. Further, at this time, charging of storage battery 21-1 is finished, and the number of times of charge and discharge of storage battery 21-1 is counted up and becomes 11 times.

Subsequently, as illustrated on a right side in FIG. 5, storage battery 21-2 is charged until the state of charge reaches 100% and the number of times of charge and discharge of storage battery 21-2 is counted up and becomes 12 times. The same processing is subsequently repeated.

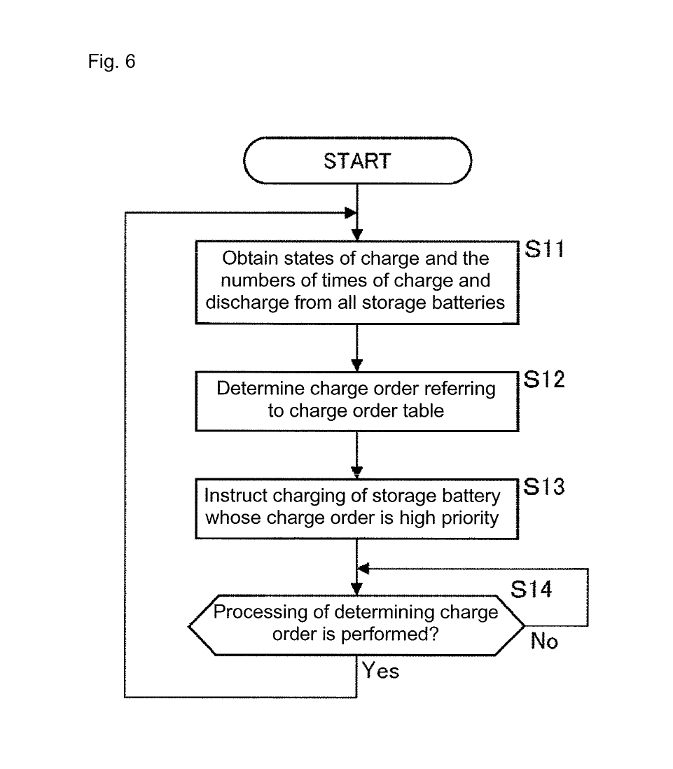

Next, a method of controlling charging of storage batteries 21-1 to 21-3 will be described with reference to a flowchart in FIG. 6.

When, for example, charging storage batteries 21-1 to 21-3 using power in a predetermined time zone is set, processing starts at a time at which starting charging is set. In step S11, data obtaining unit 42 obtains data indicating states of charge and the numbers of times of charge and discharge from all storage batteries 21 which power storage system 11 has. Further, data obtaining unit 42 supplies data indicating the states of charge and the numbers of times of charge and discharge of storage batteries 21-1 to 21-3, to charge order determining unit 43.

In step S12, charge order determining unit 43 determines charge orders of storage batteries 21-1 to 21-3 as described above with reference to FIGS. 4 and 5, based on the data supplied from data obtaining unit 42 referring to the charge order table stored in memory 32.

In step S13, charge instructing unit 44 transmits a control signal for instructing charger 22 to charge storage battery 21 whose charge order is a high priority according to the charge order determined by charge order determining unit 43 in step S12. In addition, when charge orders of a plurality of storage batteries 21 are the same, charge instructing unit 44 compares the numbers of times of charge and discharge of these storage batteries 21 and instructs charging of storage battery 21 whose number of times of charge and discharge is smaller.

In step S14, deciding unit 45 decides whether or not to perform processing of determining charge orders by charge order determining unit 43, based on the data obtained by data obtaining unit 42 on a regular basis and indicating the states of charge of storage batteries 21-1 to 21-3. As described above with reference to, for example, FIGS. 4 and 5, when the state of charge of storage battery 21 which is being charged exceeds the above second threshold, deciding unit 45 decides to perform processing of determining charge orders by charge order determining unit 43.

In step S14, processing stands by until it is decided that charge order determining unit 43 performs processing of determining charge orders, and processing returns to step S11 when it is determined that charge order determining unit 43 performs processing of determining charge orders. The same processing is subsequently performed.

As described above, power storage system 11 can determine an order to charge storage batteries 21-1 to 21-3 based on the states of charge and the numbers of times of charge of storage batteries 21-1 to 21-3. Consequently, power storage system 11 can charge 21-1 to 21-3 by keeping a balance between the operating lives of storage batteries 21-1 to 21-3 and the states of charge of storage batteries 21-1 to 21-3 and, consequently, can fulfill better performance as a whole.

That is, power storage system 11 charges storage batteries 21-1 to 21-3 such that the number of times of charge and discharge of one of storage batteries 21-1 to 21-3 does not stand out or the states of charge of storage batteries 21-1 to 21-3 do not vary. Consequently, it is possible to avoid that the operating lives of storage batteries 21-1 to 21-3 become disproportionate and the time for driving at a maximum capacity upon blackout shortens, that is, system performance lowers as a whole.

That is, power storage system 11 can average the operating lives of storage batteries 21-1 to 21-3 and make the operating life of the entire system longer and make longer a time for driving at a maximum capacity upon blackout, and, consequently, fulfill better performance. Further, power storage system 11 determines charge orders of storage batteries 21-1 to 21-3 using the charge order table to which the charge orders are set based on states of charge and the number of times of charge, and, consequently, can determine the charge orders by more simple processing.

Furthermore, power storage system 11 charges storage battery 21 one by one according to charge orders and, consequently, can avoid that a large current flows when a plurality of storage batteries 21 are simultaneously charged. Consequently, it is possible to avoid that, for example, subscribed power increases due to introduction of power storage system 11, and it is possible to reduce discharge opportunities such as peak cuts.

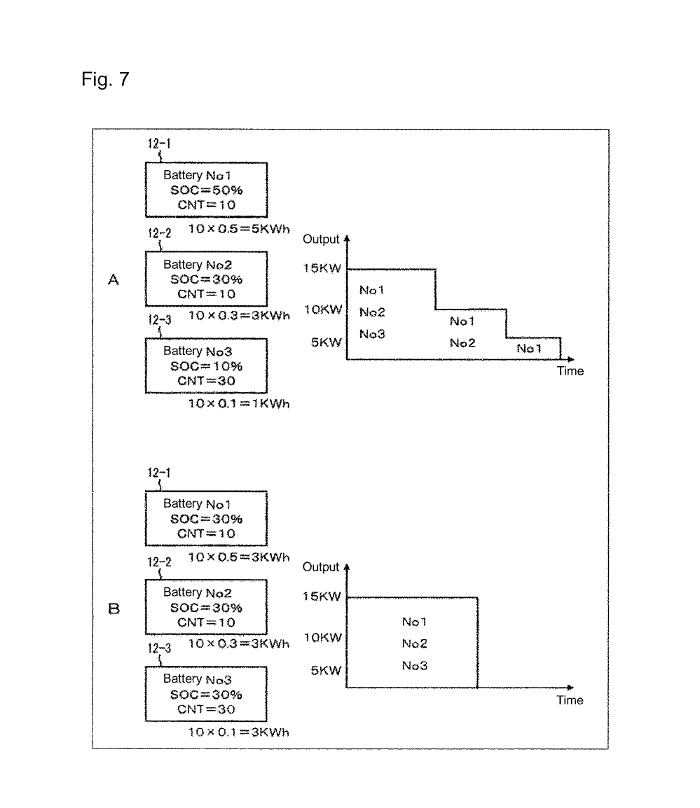

Hereinafter, that a time for driving at a maximum capacity upon blackout can be made longer in power storage system 11 will be described with reference to FIGS. 7A and 7B.

FIG. 7A illustrates storage batteries 21-1 to 21-3 whose states of charge vary, and FIG. 7B illustrates storage batteries 21-1 to 21-3 whose states of charge do not vary.

As illustrated in FIG. 7A, the state of charge of storage battery 21-1 is 50%, the state of charge of storage battery 21-2 is 30% and the state of charge of storage battery 21-3 is 10%. In this case, when capacities which can be stored in storage batteries 21-1 to 21-3 are 10 KWh, the capacity stored in storage battery 21-1 is 5 KWh, the capacity stored in storage battery 21-3 is 3 KWh and the capacity stored in storage battery 21-3 is 1 KWh.

Thus, when the states of charge of storage batteries 21-1 to 21-3 vary, a time for driving at 15 KW which is the maximum capacity of all storage batteries 21-1 to 21-3 is until power stored in storage battery 21-3 is consumed as indicated by a graph on the right side in FIG. 7A. Subsequently, after driving is performed at 10 KW until power stored in storage battery 21-2 is consumed, driving is performed at 5 KW using storage battery 21-1.

Meanwhile, as illustrated in FIG. 7B, the states of charge of storage batteries 21-1 to 21-3 are 30% and are uniform. In this case, when the capacities which can be stored in storage batteries 21-1 to 21-3 are 10 KWh, the capacities stored in storage batteries 21-1 to 21-3 are each 3 KWh.

Thus, when the states of charge of storage batteries 21-1 to 21-3 do not vary, a time for driving at 15 KW which is the maximum capacity of all storage batteries 21-1 to 21-3 is until power stored in all storage batteries 21-1 to 21-3 is consumed as indicated by a graph on the right side in FIG. 7B. That is, storage batteries 21-1 to 21-3 can provide an output at 15 KW to the last time when power of storage batteries 21-1 to 21-3 is completely consumed.

Hence, even if total capacities (graph areas) of storage batteries 21-1 to 21-3 are both 9 KWh and the same in the example in FIG. 7A and the example in FIG. 7B, a time for driving at 15 KW which is a maximum capacity of all storage batteries 21-1 to 21-3 is longer when states of charge of storage batteries 21-1 to 21-3 do not vary.

As described above, power storage system 11 determines charge orders of storage batteries 21-1 to 21-3 referring to the charge order table to which the charge orders are set based on states of charge and, consequently, can prevent the states of charge of storage batteries 21-1 to 21-3 from varying and charge storage batteries 21-1 to 21-3 such that the states of charge of storage batteries 21-1 to 21-3 become more uniform. Consequently, power storage system 11 can make a time for driving at a maximum capacity even upon blackout longer.

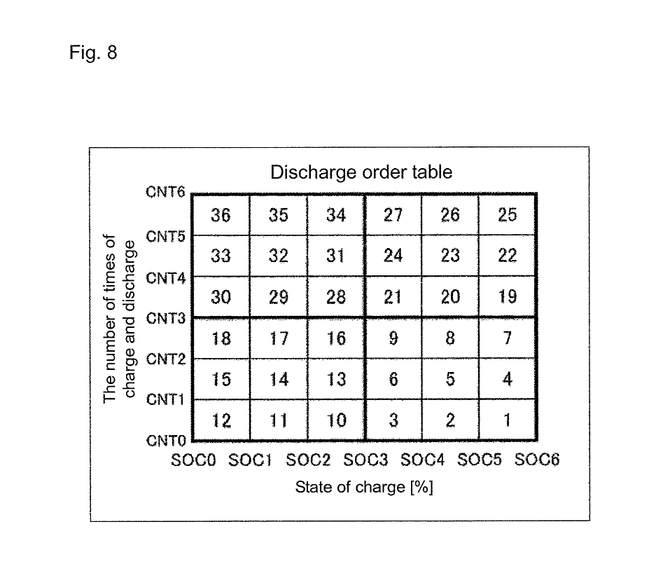

Next, processing of determining discharge orders of storage batteries 21-1 to 21-3 will be described with reference to FIG. 8.

FIG. 8 illustrates a discharge order table which is partitioned by the numbers of times of charge and discharge and states of discharge similar to the charge order table illustrated in FIG. 2, and to which discharge orders symmetric to the charge orders set to the charge order table are set. That is, in the discharge order table, discharge orders of higher priorities are sequentially set to preferentially to a row of cells whose numbers of times of charge and discharge are small and preferentially to cells of each row whose states of charge are high.

That is, in the discharge order table, discharge order “1” to discharge order “9” of the highest priorities are set to nine cells of a second group including the nine cells whose numbers of times of charge and discharge are the number of times of charge and discharge CNT3 or less and whose states of charge are higher than state of charge SOC3. Further, discharge order “10” to discharge order “18” whose priorities are the next highest to those of the second group are set to nine cells of a first group including the nine cells whose numbers of times of charge and discharge are the number of times of charge and discharge CNT3 or less and whose states of charge are state of charge SOC3 or less.

Furthermore, discharge order “19” to discharge order “27” whose priorities are the next highest to those of the first group are set to a fourth group including nine cells whose numbers of times of charge and discharge are larger than the number of times of charge and discharge CNT3 and whose states of charge are higher than state of charge SOC3. Still further, discharge order “28” to discharge order “36” whose priorities are the next highest to those of the fourth group are set to a third group including nine cells whose numbers of times of charge and discharge are larger than the number of times of charge and discharge CNT3 and whose states of charge are state of charge SOC3 or less.

In power storage system 11, similar to processing of determining charge orders, CPU 33 determines discharge orders based on the numbers of times of charge and discharge and the states of charge of storage batteries 21-1 to 21-3 referring to the discharge order table to which the discharge orders are set. Consequently, even when storage batteries 21-1 to 21-3 are discharged, it is possible to prevent the numbers of times of charge and discharge of storage batteries 21-1 to 21-3 from varying and discharge storage batteries 21-1 to 21-3 such that the states of charge of storage batteries 21-1 to 21-3 become uniform. Consequently, power storage system 11 can fulfill better performance as a whole.

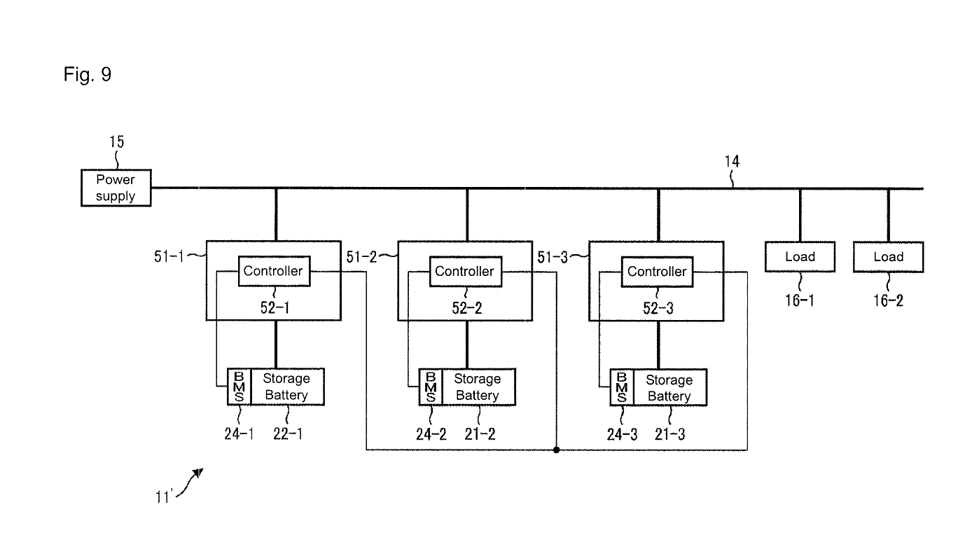

Next, FIG. 9 is a block diagram illustrating a configuration example of a power storage system of a second embodiment to which the present technology is applied.

The same components of power storage system 11′ illustrated in FIG. 9 as those of power storage system 11 in FIG. 1 will be assigned the same reference numerals, and will not be described in detail. That is, power storage system 11′ is the same as power storage system 11 in FIG. 1 in having storage batteries 21-1 to 21-3 and battery management systems 24-1 to 24-3, and connecting power supply 15 and loads 16-1 and 16-2 through power wiring 14.

Meanwhile, power storage system 11′ is configured differently from power storage system 11 in FIG. 1 in having power conditioners 51-1 to 51-3, providing controllers 52-1 to 52-3 in power conditioners 51-1 to 51-3 and connecting storage batteries 21-1 to 21-3 to power wiring 14 through power conditioners 51-1 to 51-3. In addition, power conditioners 51-1 to 51-3 are configured likewise, respectively, and, when power conditioners 51-1 to 51-3 do not need to be distinguished, power conditioners 51-1 to 51-3 are referred to as power conditioner 51 below. Further, the same also applies to controller 52.

Power conditioners 51-1 to 51-3 adjust power inputted and outputted according to states of charge of storage batteries 21-1 to 21-3, and charge power to storage batteries 21-1 to 21-3 or discharge power from storage batteries 21-1 to 21-3.

Controllers 52-1 to 52-3 are connected with corresponding battery management systems 24-1 to 24-3 through communication wirings, and controllers 52-1 to 52-3 are connected with each other through communication wirings. Further, controllers 52-1 to 52-3 obtain data indicating states of charge and the numbers of times of charge and discharge of storage batteries 21-1 to 21-3 from corresponding battery management systems 24-1 to 24-3. Furthermore, controllers 52-1 to 52-3 communicate with each other to determine charge orders of storage batteries 21-1 to 21-3 to charge.

That is, controllers 52-1 to 52-3 determine the charge orders of corresponding storage batteries 21-1 to 21-3 referring to the charge order table. Further, controllers 52-1 to 52-3 compare the respective charge orders, and controller 52 corresponding to storage battery 21 whose charge order is the highest priority charges storage battery 21. Furthermore, controller 52 corresponding to storage battery 21 which is being charged notifies to other controllers 52 that other controllers 52 need to perform processing of determining charge orders when the state of charge of this storage battery 21 exceeds a second threshold, and charge orders are determined again.

Consequently, power storage system 11′ can fulfill better performance as a whole similar to power storage system 11 without having control device 13 which controls the entirety of power storage system 11.

In addition, the embodiment where charge orders are set in advance to the charge order table stored in memory 32 and CPU 33 determines charge orders of storage batteries 21-1 to 21-3 referring to the charge order table has been described. However, CPU 33 may determine charge orders without referring to the charge order table. For example, CPU 33 can determine charge orders decided based on the numbers of times of charge and discharge and states of charge of storage batteries 21-1 to 21-3 using a decision condition to which charge orders are set in advance based on the numbers of times of charge and discharge and the states of charge similar to the charge order table.

Further, the number of times of charge and discharge described above and, in addition, one or both of the number of times of charge and the number of times of discharge may be used for parameters for determining charge orders of storage batteries 21. Furthermore, the above states of charge of storage batteries 21 and, in addition, voltages of storage batteries 21 may be used for parameters for determining charge orders of storage batteries 21. When these parameters are used, charge orders are determined referring to a charge order table created according to these parameters.

In addition, the above series of processing can also be executed by hardware and can also be executed by software. When the series of processing is executed by software, a program configuring this software is installed from a program recording medium to a computer embedded in dedicated hardware or to, for example, a general-purpose personal computer which can execute various functions by installing various programs.

Further, these programs can be stored in a memory unit in advance. In addition, these programs can be installed in the computer through a communication unit formed with a network interface or through a drive which drives removable media such as magnetic disks (including flexible disks), optical disks (CD-ROMs (Compact Disc-Read Only Memory) and DVDs (Digital Versatile Disc)), magnetooptical disks and semiconductor memories.

Further, each processing described with reference to the above flowchart may not be necessarily processed in the time sequence in order described as the flowchart, and also includes processing (e.g. parallel processing or processing by an object) executed individually or in parallel. In addition, in this description, the system refers to an entire apparatus formed with a plurality of apparatuses.

In addition, the embodiments are not limited to the above-described embodiments, and can be variously changed as long as the changes do not deviate from the spirit of the present disclosure.

### DESCRIPTION OF SYMBOLS

11 Power storage system

12 power storage device

13 Control device

14 Power wiring

15 Power supply

16 Load

21 Storage battery

22 Charger

23 Discharger

24 Battery management system

31 Input/output unit

32 Memory

33 CPU

41 Storage battery control device

42 Data obtaining unit

43 Charge order determining unit

44 Charge order determining unit

45 Deciding unit

51 Power conditioner

52 Controller

1-9. (canceled)

10. A storage battery control device comprising:
a setting unit configured to be set in advance with an order to charge or discharge a storage battery according to at least two parameters configured to define an operating life and an output of the storage battery configured to store power;
a determining unit configured to determine the storage battery to be charged or discharged among a plurality of storage batteries based on the parameters obtained from the plurality of storage batteries referring to the order set in advance to the setting unit;
an obtaining unit configured to obtain the parameters from the plurality of storage batteries; and
a deciding unit configured to decide that the determining unit performs processing of determining the storage battery to be charged or discharged when the parameters obtained by the obtaining unit from the storage battery which is being charged exceed a predetermined threshold.

11. The storage battery control device according to claim 10, wherein
the two parameters configured to define the operating life and the output of the storage battery are a state of charge and the number of times of charge and discharge of the storage battery, and
the setting unit is a table to which an order to charge or discharge the storage battery is set in advance based on the state of charge and the number of times of charge and discharge of the storage battery.

12. The storage battery control device according to claim 11, wherein the order to charge the storage battery is preferentially set to a row of a cell whose number of times of charge and discharge is small and is preferentially set to a cell of each row whose state of charge is low in the table.

13. The storage battery control device according to claim 11, wherein the order to discharge the storage battery is preferentially set to a row of a cell whose number of times of charge and discharge is small and is set preferentially to a cell of each row whose state of charge is high in the table.

14. A storage battery control method, wherein
an order to charge or discharge a storage battery is set in advance according to at least two parameters configured to define an operating life and an output of the storage battery configured to store power, and
the storage battery control method comprising the steps of:
determining the storage battery to be charged or discharged among a plurality of storage batteries based on the parameters obtained from the plurality of storage batteries referring to the order set in advance;
obtaining the parameters from the plurality of storage batteries; and
deciding to perform processing of determining the storage battery to be charged or discharged when the parameters obtained from the storage battery which is being charged exceed a predetermined threshold.

15. A program, wherein
an order to charge or discharge a storage battery is set in advance according to at least two parameters configured to define an operating life and an output of the storage battery configured to store power, and
the program causes a computer to execute processing comprising:
determining the storage battery to be charged or discharged among a plurality of storage batteries based on the parameters obtained from the plurality of storage batteries referring to the order set in advance;
obtaining the parameters from the plurality of storage batteries; and
deciding to perform processing of determining the storage battery to be charged or discharged when the parameters obtained from the storage battery which is being charged exceed a predetermined threshold.

16. A power storage system comprising:
a plurality of storage batteries configured to store power;
a setting unit configured to be set in advance with an order to charge or discharge the storage batteries according to at least two parameters configured to define operating lives and outputs of the storage batteries;
a determining unit configured to determine the storage battery to be charged or discharged among the plurality of storage batteries based on the parameters obtained from the plurality of storage batteries referring to the order set in advance to the setting unit;
an obtaining unit configured to obtain the parameters from the plurality or storage batteries; and
a deciding unit configured to decide that the determining unit performs processing of determining the storage battery to be charged or discharged when the parameters obtained by the obtaining unit from the storage battery which is being charged exceed a predetermined threshold.

17. A power supply system comprising:
a power supply configured to include at least one of a direct-current power supply configured to use natural energy and an alternating-current power supply configured to supply power through a power system;
a load configured to be connected to the power supply through a power wiring and consume power;
a plurality of storage batteries configured to be connected in parallel to the power supply through the power wiring and store the power;
a setting unit configured to be set in advance with an order to charge or discharge the storage batteries according to at least two parameters configured to define operating lives and outputs of the storage batteries;
a determining unit configured to determine the storage battery to be charged or discharged among the plurality of storage batteries based on the parameters obtained from the plurality of storage batteries referring to the order set in advance to the setting unit; and
a deciding unit configured to decide that the determining unit performs processing of determining the storage battery to be charged or discharged when the parameters obtained by an obtaining unit from the storage battery which is being charged exceed a predetermined threshold.
